(19) United States
(12) Patent Application Publication
(10) Pub. No.: US 2016/0026609 A1
(43) Pub. Date: Jan. 28, 2016

(54) Appending New Content to Open Content

(71) Applicant: Adobe Systems Incorporated, San Jose, CA (US)

(72) Inventor: Robin James Adams, San Francisco, CA (US)

(21) Appl. No.: 14/337,456

(22) Filed: Jul. 22, 2014

(51) Int. Cl. G06F 17/22; G06F 3/0484; H04L 29/08

(52) U.S. Cl. CPC G06F 17/2235; G06F 17/2247; H04L 67/02; G06F 3/0484

(57) ABSTRACT

Techniques for appending new content to open content are described. In one or more embodiments, content having one or more hyperlinks associated with additional content is displayed. In implementations, a user selection of one of the hyperlinks is received. In response to receiving the user selection, the additional content associated with the hyperlink is added to the displayed content. In one or more embodiments, the content and the additional content are displayed together as a single content chain.

### BACKGROUND

Conventional techniques used for opening new content, such as to view a new document, for example, can include opening the new content in a new browser window or a new tab. Although these techniques may be desirable in some circumstances, these conventional techniques may lead to a clutter of tabs or windows on some devices such as desktop computers, and may not be a viable solution on other devices such as small-interface devices that have limited screen display space.

### SUMMARY

Techniques for appending new content to open content are described. In one or more embodiments, content having one or more hyperlinks associated with additional content is displayed. A user selection of one of the hyperlinks can be received, and the additional content associated with the hyperlink is added to the displayed content. The content and the additional content are then displayed together as a single content chain.

In embodiments, a document manager module is implemented by a system to open a new document by appending the new document to an open document in response to a user selection of a hyperlink associated with the open document. In implementations, a display is initiated of the open document and the new document to be displayed as a single document chain.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to implement techniques for appending new content to open content.

FIG. 2 is an illustration of an example implementation in which techniques for appending new content to open content are used in accordance with one or more embodiments.

FIG. 3 is an illustration of an example graphical user interface that can be used to display content in accordance with one or more embodiments.

FIG. 4 is an illustration of an example graphical user interface that can be used to display content in a document chain in accordance with one or more embodiments.

FIG. 5 is an illustration of example modifications to a displayed document chain in accordance with one or more embodiments.

FIG. 6 is a flow diagram depicting a procedure in an example implementation in which techniques for appending new content to open content are used in accordance with one or more embodiments.

FIG. 7 is a flow diagram depicting a procedure in an example implementation in which new documents are appended to open documents in accordance with one or more embodiments.

FIG. 8 illustrates various components of an example device that can be implemented as any type of computing device as described herein to implement embodiments of the techniques described herein.

### DETAILED DESCRIPTION

### Overview

Conventional techniques used for opening new content on a display device can lead to screen clutter on large-interface devices and may not be a viable solution for small-interface devices. For example, a mobile device can be used to present a document for a user to read and with which the user may interact, such as by clicking on a link, to view a new document. The new document may be opened in a new browser window or a new tab. In some instances, the new document may replace the display of the current document. If, however, the user wants to maintain the display of the current document, such as if the user is not finished reading the current document, replacing the current document with the new document may cause user frustration and require the user to navigate back to the current document to finish reading.

Techniques for appending new content to current content are described. In the following discussion, a variety of different implementations are described that involve opening new content in a same browser interface, window, or tab as the current content. In one example, if the reader interacts with a first document that is open and displayed, such as by selecting a hyperlink configured to open a second document, the second document can be appended to the first document. If the reader then opens a third document, the third document can be appended to the second document to create a single chain of the first, second, and third documents within a same tab or browser interface window. This allows the reader to consolidate one reading session within a single tab or window so as to reduce tab clutter and facilitate easier continuous reading. These techniques may also improve the user's reading experience on devices with small screen display space that, for example, resort to separate modes such as a multi-window mode.

Some websites may implement an ability to load additional content responsive to the user scrolling to the end of the current document, rather than requiring the user to select a “Next” button, for example. This automatic addition of content can be referred to as an “infinite scroll,” and generally, the added content includes random content, or targeted content that is targeted to the user based on viewing history, or content that is similar to the current content. However, the infinite scroll technique does not add content that is explicitly selected by the user. In the techniques described herein, the new content that is appended to current content is user-selected to effectively build a user-defined content chain.

As used herein, the term “item” is representative of an object that is displayable via a display device. An object is representative of a location in memory having a value and referenced by an identifier. An object can be a data structure, a variable, a function, an instance of a class, a table, a column, an association between data and a database entity, and so on. Some examples of objects can include files, text, images, audio data, video data, audio/video data, and so on. Other examples of objects include items, such as items in a table, a column, a list of items, and so on. Thus, the term “item” can represent any of a variety of objects.

As used herein, the term “content” is representative of data, such as text content (e.g., messages), photographs, video, audio, and so on. Additionally, the content can include one or more objects. The content can be displayed for the user, and can be selectable by the user to perform one or more actions. Some example actions include opening new content, opening a new document, navigating to a different location within an open document, navigating to a new document in a new window or a new tab, defining a term, and so on. Further examples of the above-described terms may be found in relation to the following discussion.

As used herein, the term “hyperlink” is representative of a hypertext link or other link that is a selectable connection from one word, picture, or information object to another. In a multimedia environment, such as the Internet, such objects can include sound and motion video sequences. Some forms of hyperlinks include a highlighted word or picture that can be selected by a user, resulting in delivery and display of another file. The highlighted object may be referred to as an anchor. The anchor reference and the object referred to may constitute a hypertext link. A variety of different types of links are contemplated, such as a definition of the object, an example of the object, a picture of the object, a different sized picture of the object, a map of the object, an indication of where to open a file associated with the object, and so on. Thus the term “hyperlink” can represent a variety of links.

In the following discussion, an example environment is first described that may employ the techniques described herein. Following this, example implementations are described that utilize the techniques described herein for appending new content to open content. Example procedures for appending new content to open content are then described which may be performed in the example environment as well as other environments. Consequently, performance of the example procedures is not limited to the example environment and/or the example implementations, and the example environment and/or the example implementations are not limited to performance of the example procedures.

### Example Environment

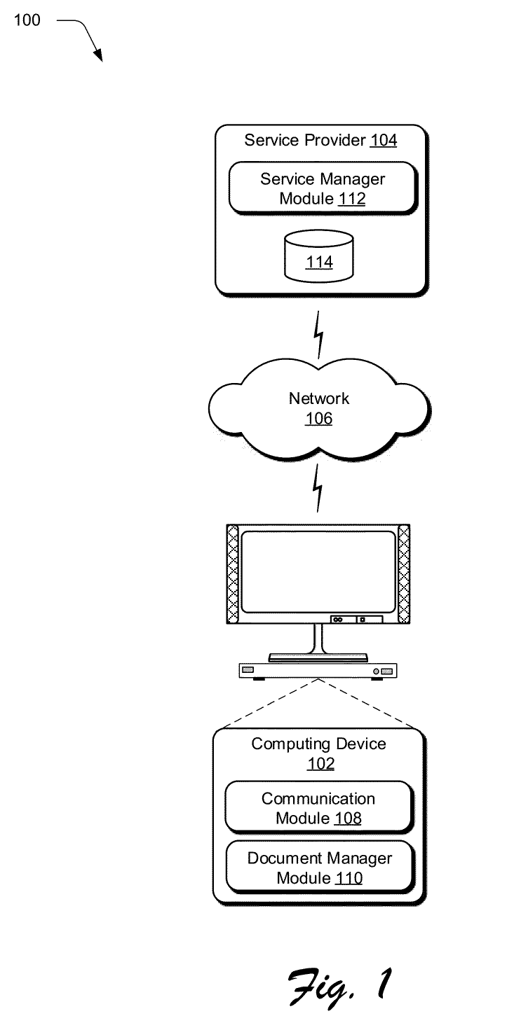

FIG. 1 is an illustration of an environment 100 in an example implementation that is operable to employ techniques described herein. The illustrated environment 100 includes a computing device 102 and a service provider 104 that are communicatively coupled via a network 106. The computing device 102, as well as computing devices that implement the service provider 104, may be configured in a variety of ways.

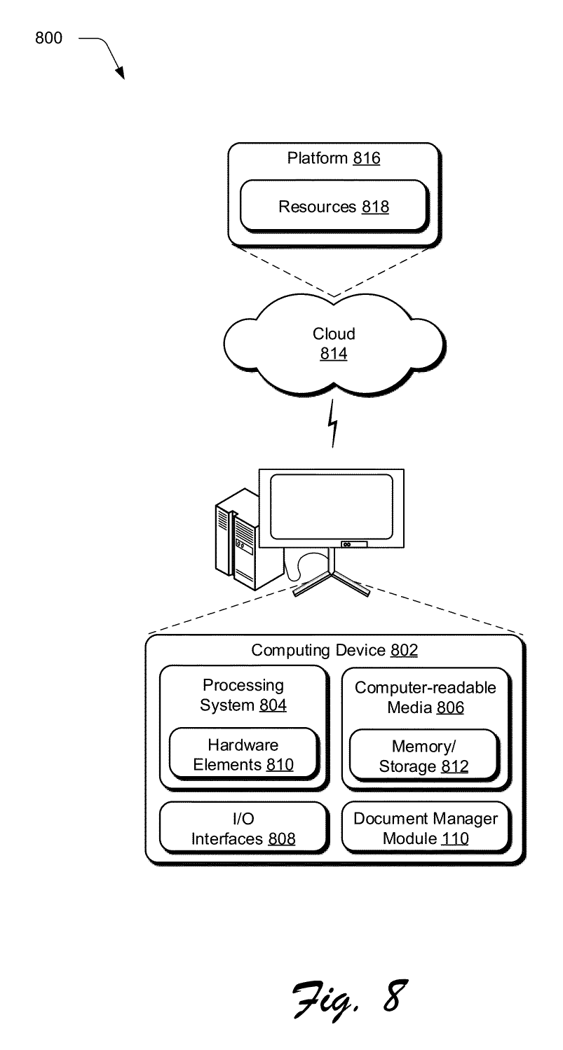

The computing devices, for example, may be configured as a desktop computer, a laptop computer, a mobile device (e.g., assuming a handheld configuration such as a tablet or mobile phone), and so forth. Additionally, a computing device may be representative of a plurality of different devices, such as multiple servers of the service provider 104 utilized by a business to perform operations “over the cloud” as further described in relation to FIG. 8, and so on.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be representative of multiple networks.

The computing device 102 is also illustrated as including a communication module 108. The communication module 108 is representative of functionality to communicate via the network 106, such as with one or more services of the service provider 104. As such, the communication module 108 may be configured in a variety of ways. For example, the communication module 108 may be configured as a browser that is configured to “surf the web.” The communication module 108 may also be representative of network access functionality that may be incorporated as part of an application, e.g., to provide network-based functionality as part of the application, an operating system, and so on. Thus, functionality represented by the communication module 108 may be incorporated by the computing device 102 in a variety of different ways.

The document manager module 110 is representative of functionality to manage content on the computing device 102. As such, the document manager module 110 may be configured in a variety of ways. For example, the document manager module 110 may be configured to open new content in response to a user selection of a hyperlink embedded within currently displayed content. The document manager module 110 can designate a location in which to open the new content, such as in a new window, a new tab, or in the same window or tab as the currently displayed content. Additionally, the document manager module 110 can cause the new content to be opened in the designated location.

The service provider 104 is representative of functionality of the service provider 104 to provide one or more network-based services. The services are managed by a service manager module 112 to support a variety of different functionality. The services (e.g., web services), for instance, may be configured to support word processing, spreadsheets, graphics composition, graphics editing, sound editing, presentations, multimedia editing, three-dimensional scene rendering for video and/or film, video and/or motion graphics rendering, video transcoding, and so on. Thus, a variety of different types of content may be displayed and/or edited (e.g., created and/or modified) by the services, which may be maintained in the storage 114 of the service provider 104.

### Example Implementations

The following discussion describes example devices and graphical user interfaces (GUIs) that can be employed to perform various aspects of techniques discussed herein in accordance with one or more embodiments. The example devices and GUIs may be employed in the environment 100 of FIG. 1, the system 800 of FIG. 8, and/or any other suitable environment.

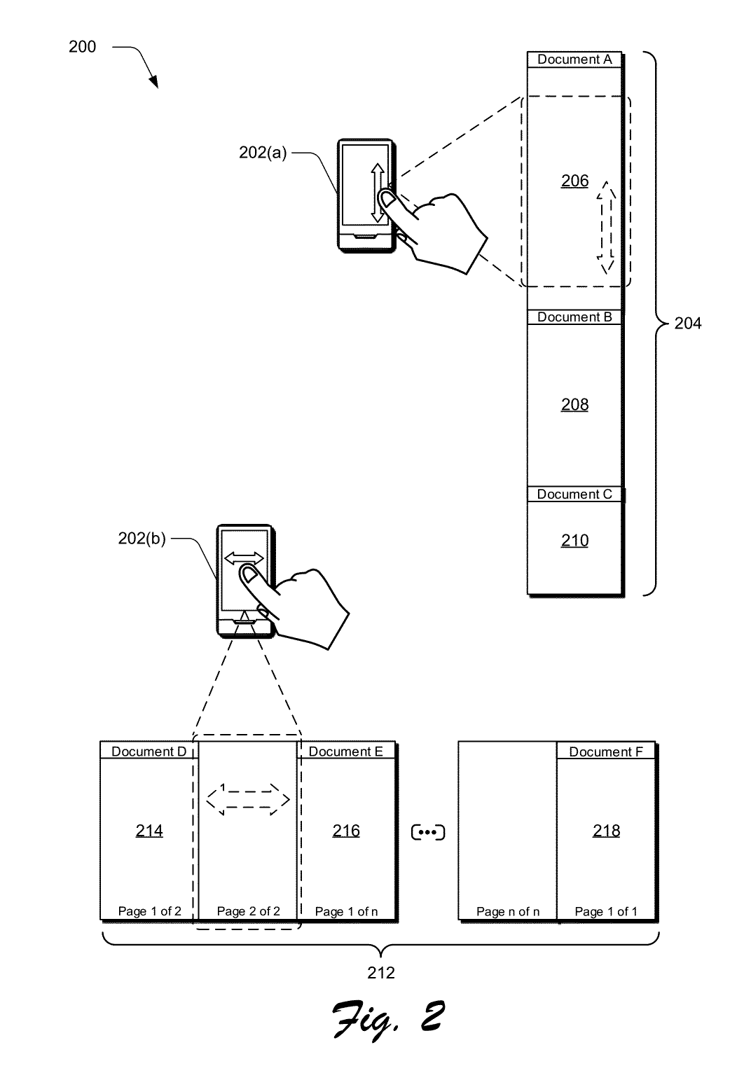

FIG. 2 is an illustration of an example implementation 200 in which techniques for appending new content to open content are used in accordance with one or more embodiments. FIG. 2 includes computing devices 202(a) and 202(b), which are examples of the computing device 102 from FIG. 1. Although the computing devices 202(a) and 202(b) are illustrated as mobile phones, the computing devices 202(a) and 202(b) may include any of a variety of computing devices as described herein, such as tablets, desktop computers, game consoles, and so on. Accordingly, the computing devices 202(a) and 202(b) are not limited to the illustrated examples.

Generally, a computing device can only display a portion of content when the content includes a large amount of data to be displayed on a relatively small display device. Resolution and/or screen size of the display device may also adversely affect how much of the content can be displayed on the display device in a manner (e.g., size and clarity) that is usable by the user.

In embodiments, content to be displayed can include one or more pages, and the display device can be configured to display at least a portion of the one or more pages. Based on the amount of data in the content to be displayed, the user may scroll through the content vertically, or horizontally, or both to view other portions of the content.

In embodiments, pages of a document may be displayed vertically, such as pages with a predefined width that are displayed above and/or below one another in a vertical configuration. This vertical configuration allows a user to scroll vertically through the pages of the document. Additionally or alternatively, the content may be displayed horizontally such that, for example, pages of a document are displayed sequentially in a horizontal configuration to allow the user to scroll right or left to a next or previous page of the document. Accordingly, the content can be displayed in a variety of ways on the computing device.

When a new document is opened, the new document may be appended to an open document. For example, FIG. 2 illustrates the computing device 202(a) as displaying a portion of the document chain 204. The document chain 204 can be created by appending open documents together in a sequence. For example, the computing device 202(a) is illustrated as displaying an open document, e.g., Document A 206. When Document B 208 is opened, Document B 208 can be appended to Document A 206, which enables continuous scrolling between Documents A 206 and B 208. When another document, such as Document C 210, is opened, Document C 210 can be appended to the document chain 204 such that the user can scroll through the document chain 204 from Document B 208 to Document C 210. In this example, the user may scroll vertically through the single document chain 204. In this way, the user's reading experience may continue without the user having to navigate to a different window, tab, or interface.

In implementations, computing device 202(b) may be configured to display pages of content horizontally. For example, FIG. 2 illustrates computing device 202(b) as displaying a portion of a document chain 212. The document chain 212 can be created by appending open documents together in a sequence, similar to the creation of the document chain 204 discussed above. For example, the computing device 202(b) can display a portion of Document D 214, such as page 2. When a new document, such as Document E 216, is opened, pages 1-n of Document E 216 can be appended to page 2 of Document D 214 in a horizontal sequence, allowing the user to scroll left or right through the pages of both Documents D 214 and E 216 in the same browser window and/or the same tab of a browser interface. Additional documents, may be appended to the document chain 212 when opened. For example, the user can open Document F 218 and cause Document F 218 to be appended to the document chain 212, such as by appending Document F 218 to Document E 216.

In implementations, newly opened documents may be appended to the end of the last document in the document chain. In at least some embodiments, the new document can be opened without automatically navigating to the new document. Instead, a currently displayed document may remain displayed on the display device while the new document is appended to the document chain. In one or more implementations, the new document can have a file format that is the same as a file format of the currently displayed document. Alternatively, the file format of the new document can be different than the file format of the currently displayed document. In some embodiments, the new document can be modified to match the file format of the currently displayed document to display the new document in the same browser interface as the currently displayed document. The document manager module 110 of FIG. 1 can be configured for converting the file format of the new document.

In embodiments, a notification can be presented to indicate to the user that the new document has been opened and appended to the currently displayed document. In this way, the user may continue reading the currently displayed document while having the reassurance that the new document is open and can be immediately encountered upon reaching the end of the current document.

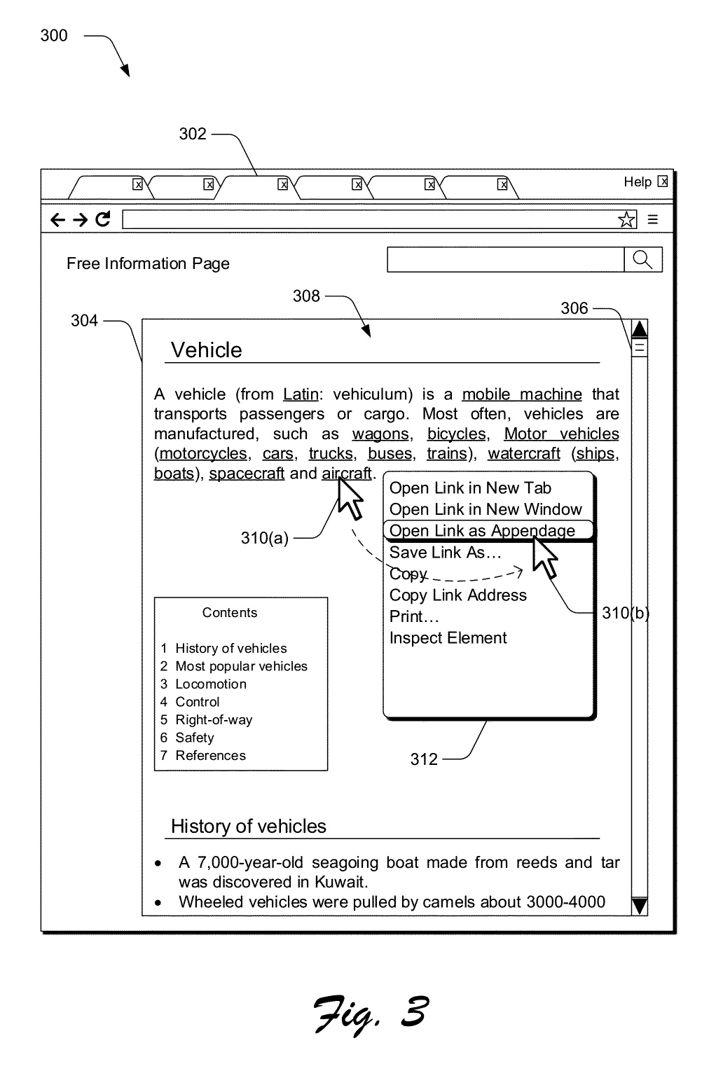

FIG. 3 illustrates an example graphical user interface (GUI) 300 that can be used according to various embodiments discussed herein. For example, the GUI 300 may be implemented by the document manager module 110 of FIG. 1 to display content received over the network 106 or to display locally stored content. The GUI 300 illustrates an example browser interface with multiple tabs. One or more of the tabs can be used to display content. The GUI 300 illustrates an example tab, e.g., tab 302, having a content area 304.

The content area 304 can include a variety of content, such as a document, a web page, an audio file, a presentation slide, a spreadsheet, a folder, and so on. The content displayed within the content area 304 can include one or more hyperlinks that are selectable to open new content that is displayable in the content area 304 of tab 302. Additionally or alternatively, the new content can be opened in a new tab, a new window, or a new browser interface. The GUI 300 also illustrates a navigation instrumentality, such as a scroll bar 306, to scroll through the content displayed in content area 304. Although the scroll bar 306 is illustrated as a vertical scroll bar to vertically scroll through the content displayed in the content area 304, other configurations of the scroll bar 306 are also contemplated, such as a horizontal scroll bar, a selectable arrow located proximate to a side, top, or bottom of the content area 304, and so on.

The hyperlinks in the content can include one or more hypertext links, or other links, that are configured to cause new content to be opened responsive to selection of the hyperlink. One or more of hyperlinks may be identified by a visual indicia such as, for example, highlighting, underlining, italicizing, bolding, a difference in color compared to other displayed content, and so on. Any of a variety of visual indicia may be utilized to identify a hyperlink. In embodiments, the hyperlinks can be selectable to open new content in the content area 304. For example, the content area 304 includes a display of a portion of a document 308 that discusses the term “Vehicle” and includes multiple hyperlinks associated with different types of vehicles. The user may select, for example, the “aircraft” hyperlink by right clicking on the hyperlink with cursor 310(a) to open a menu, such as menu 312. The menu 312 can include a variety of selectable options which can include options to “Open Link in New Tab,” “Open Link in New Window,” “Open Link as Appendage,” “Save Link As . . . ,” “Copy,” “Print,” and so on. If the user selects the option to open the link as an appendage, as indicated by cursor 310(b), then content associated with the “aircraft” hyperlink can be appended to the document 308.

In implementations, the hyperlink can be selected via any of a variety of user inputs from any of a variety of input devices. Some examples include a gesture input via a touch screen device such as a single tap, a double tap, or a tap and hold, a mouse input such as a single click or a double click, a keyboard input or a controller input such as an actuated button, and so on. Accordingly, the hyperlink can be selected via a variety of different user inputs.

If the user selects the option to open the link as an appendage, the new content associated with the link can be opened in the same tab as the current content. For example, responsive to the user selection illustrated in GUI 300, a document discussing aircraft can be opened in the current tab 302 by appending the aircraft document to the document 308. In implementations, the content area 304 may continue displaying the current content without automatically navigating to the new content so as to not interrupt the user's reading session. The user can then scroll through the content displayed in content area 304 as a single document chain that includes both the document 308 and the appended aircraft document.

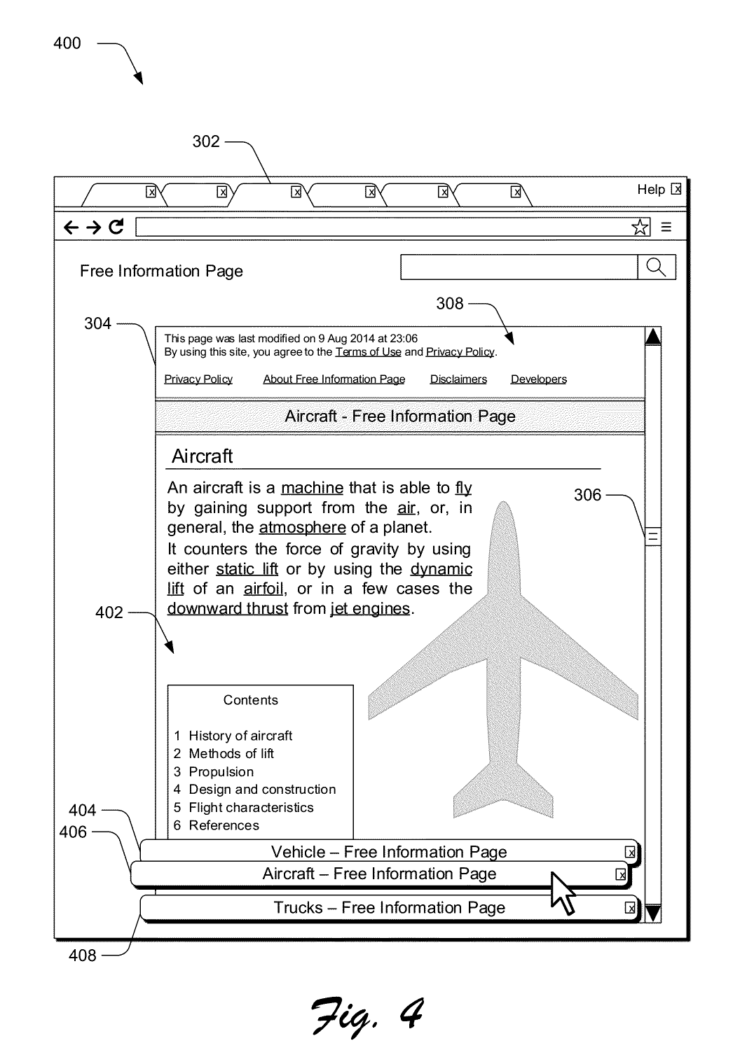

FIG. 4 illustrates and example GUI 400 that can be used according to various embodiments discussed herein. Continuing with the above example, after selecting the “aircraft” hyperlink, the user has scrolled through the content in content area 304, as indicated by the scroll bar 306, to the end of the document 308 where the aircraft document 402 is appended to the document 308 to create a document chain. Accordingly, the user can seamlessly and continuously scroll through both the document 308 and the aircraft document 402 as if they were a single continuous document.

In at least some embodiments, the GUI 400 can include a list of items that correspond to documents included in the document chain to provide the user with an indication of which documents are included in the document chain. For example, GUI 400 illustrates a list that includes items 404, 406, and 408 that correspond to the documents that are appended together in the content area 304 as a document chain. In at least some embodiments, the user can manage the documents in the document chain via the list of items, such as by changing an order of the items in the list to cause a corresponding change to a display order of the documents in the document chain. For example, the user may drag the item 406, which corresponds to the aircraft document 402, to a different location in the list of items, to cause the aircraft document 402 to be moved to a corresponding location in the display order of the documents in the document chain.

In implementations, one or more of the items are individually closeable to cause a corresponding document in the document chain to also be closed. For example, the user may close the item 406 to cause the aircraft document 402 to be closed and thereby removed from the document chain. If the document chain includes one or more documents that were appended to the aircraft document 402, those previously appended documents may be automatically appended to the same document to which the aircraft document 402 was appended prior to closing. For example, the aircraft document 402 is appended to the document 308, and a document corresponding to item 408 that discusses trucks is appended to the aircraft document 402. In response to closing the item 406, the aircraft document 402 is removed from the document chain and the document corresponding to item 408 that discusses trucks, is then automatically appended to the document 308. This helps to avoid missing portions or interruptions in the document chain.

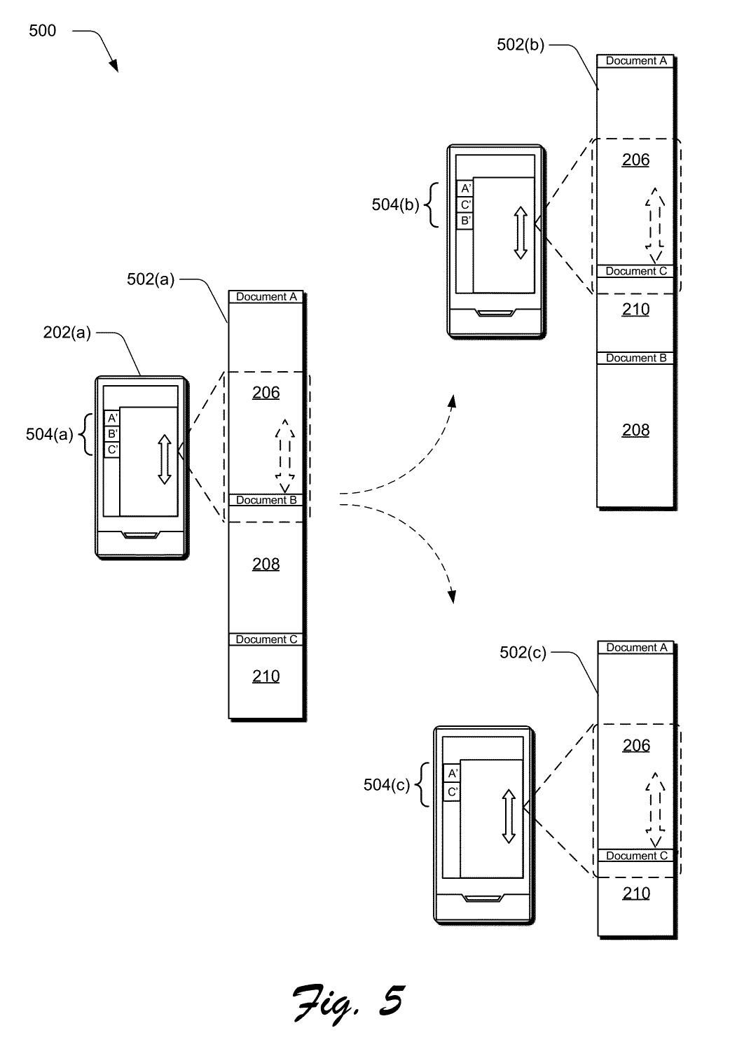

FIG. 5 is an illustration 500 of example modifications to a displayed document chain. For example, FIG. 5 illustrates the example computing device 202(a) displaying a portion of a document chain 502(a), which includes Documents A 206, B 208, and C 210. Additionally, the computing device 202(a) is illustrated as displaying a list 504(a) that includes items A′, B′, and C′ corresponding to Documents A 206, B 208, and C 210, respectively, in the document chain 502(a). In embodiments, the display order of the documents in the document chain 502(a) can be modified by changing the list order of the items in the list 504(a). In one example, the user may move the item B′ from the middle of the list 504(a) to the end of the list 504(a). In response to the move, the list order of the items in the list 504(a) is changed to that of list 504(b) having a list order of A′, C′, and B′. Additionally, responsive to the change in the list order, the display order of the documents in the document chain 502(a) is modified to create a new display order, such as the display order represented by document chain 502(b). The document chain 502(b) includes the display order of the documents in the order of Documents A 206, C 210, and B 208. Accordingly, any of the documents in the document chain can be moved to a new location within the document chain in response to a change to the list order of the corresponding items in the list. Further, the user may scroll through the document chain 502(b) in the order defined by the user, e.g., from Document A 206 to Document C 210 to Document B 208.

Additionally or in the alternative, the user may close one of the documents in the document chain. For example, assume the user closes Document B 208 in the document chain 502(a) either by closing the document directly from the browser interface or by closing item B′ in list 504(a). By closing Document B 208, Document B 208 is removed from the document chain 502(a) and the document chain 502(a) is updated to append Document C 210 to Document A 206, as illustrated by the document chain 502(c). In addition, list 504(a) is updated based on the closure of Document B 208 by removing item B′ from the list, as illustrated by list 504(c). In this way, the user can seamlessly and continuously scroll through the document chain 502(c) from Document A 206 directly to Document C 210.

### Example Procedures

The following discussion describes techniques for appending new content to open content that may be implemented according to one or more embodiments. In at least some embodiments, the techniques for appending new content to open content may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. Further, although various different procedures are described herein, a combination of the described procedures may be used to implement techniques for appending new content to open content. In portions of the following discussion, reference will be made to the environment 100 of FIG. 1.

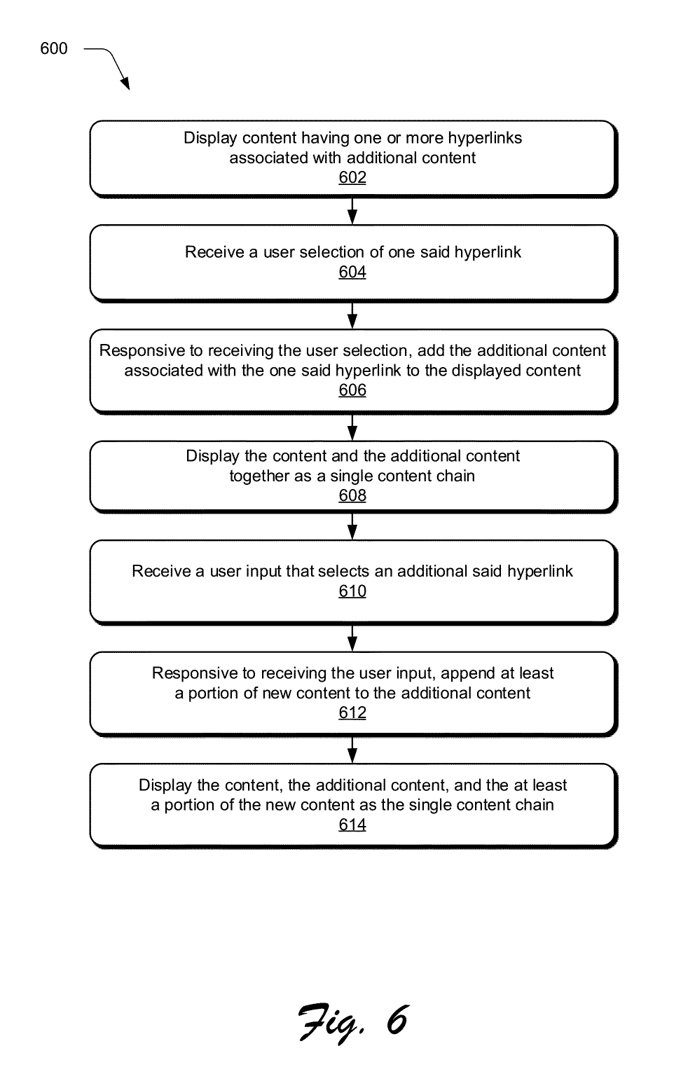

FIG. 6 is a flow diagram depicting a procedure 600 in an example implementation in which techniques for appending new content to open content are employed in accordance with one or more embodiments. Content is displayed having one or more hyperlinks associated with additional content (block 602). For example, a portion of content such as a document can be displayed on a display device, and the document can have one or more hyperlinks that are associated with one or more other documents. The hyperlinks can include any of a variety of hyperlinks, examples of which are described above.

A user selection one of the hyperlinks is received (block 604). The user selection can be received in any suitable way. For example, the user may select the hyperlink via a right click to initiate display of a menu and then select of a menu item to append the additional content to the displayed content. In at least some embodiments, the user selection can be a single click or tap, a double click or tap, or any other suitable input that selects the hyperlink.

In response to receiving the user selection, the additional content associated with the hyperlink is added to the displayed content (block 606). For example, the additional content can be appended to the displayed content to create a single content chain that includes both the displayed content and the additional content in a single tab or browser interface. In embodiments, the additional content can be appended to the displayed content without changing the display of the displayed content and without interrupting a user's reading session. In one or more implementations, the additional content can be appended to the end of the displayed content, the end of the content chain, or any other suitable location within the content chain.

The content and the additional content are displayed together as a single content chain (block 608). By displaying the content and the additional content together as a single content chain, the user can continuously and seamlessly scroll from the content to the additional content without interruption. In implementations, the displayed content and the additional content can be displayed within a same tab and/or window of a displayed browser interface. The content and the additional content can appear to the user as a single document, and may include a visual indication that identifies the end of the content and the beginning of the additional content.

A user input is received that selects an additional hyperlink (block 610). For example, the user may select an additional hyperlink that is embedded within the content or within the additional content. This additional hyperlink can be linked to new content that the user desires to open.

Responsive to receiving the user input, at least a portion of new content is appended to the additional content (block 612). For example, the new content associated with the additional hyperlink selected by the user can be appended to the end of the content chain. If the content chain ends with the additional content that was previously selected by the user, then the subsequently opened new content is appended to the previously opened additional content. In implementations, the display order of the content in the content chain is modifiable by the user rearranging an order of items in a list of items that correspond to the content in the content chain.

The content, the additional content, and at least a portion of the new content are displayed as a single content chain (block 614). For example, the single content chain is added to by appending the new content. This allows the user to seamlessly and continuously scroll through the different content in the content chain having the appearance of a single document. In this way, the user is allowed to select and manage which content is to be added to the user's reading session. Further, the displayed content is not inadvertently replaced by the additional and/or the new content, and the user is not forced to navigate to a different tab or window of the browser interface.

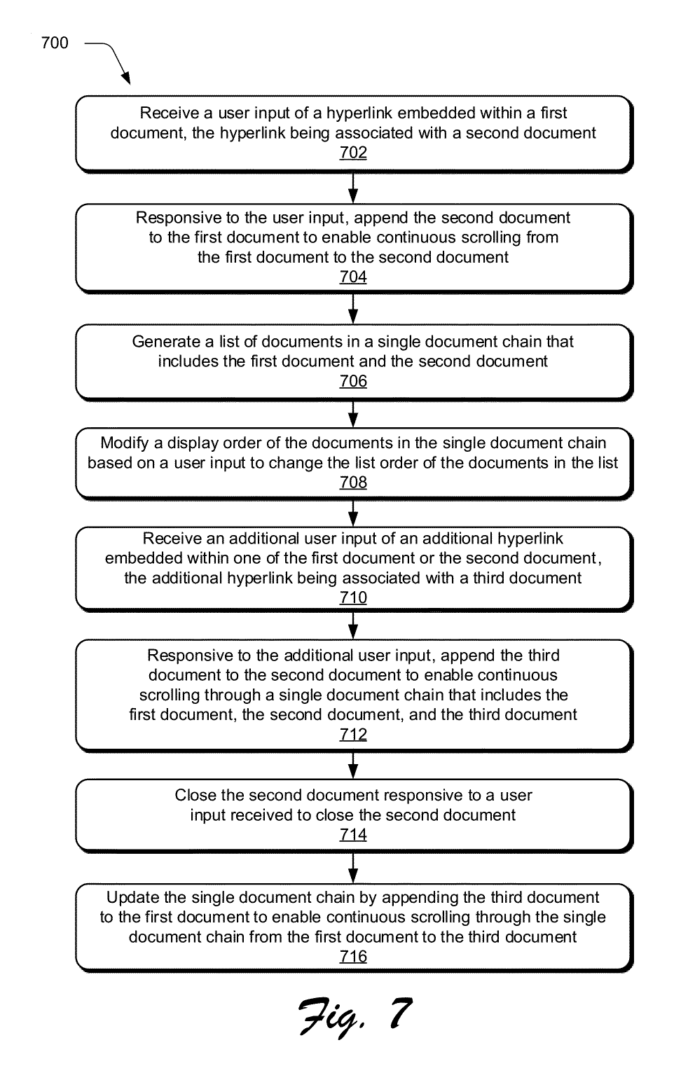

FIG. 7 is a flow diagram depicting a procedure 700 in an example implementation in which techniques for appending a new document to a current document are employed in accordance with one or more embodiments. A user input of a hyperlink embedded within a first document is received (block 702). In at least some embodiments, the hyperlink can be associated with a second document. Any suitable user input can be utilized, examples of which are described above.

Responsive to the user input, append the second document to the first document to enable continuous scrolling from the first document to the second document (block 704). For example, the second document can be appended to the end of the first document to create a single document chain. The user may scroll through the single document chain from the first document to the second document seamlessly and without interruption as if the first and second documents were a single document. The single document chain can include an indication of a location where the first document ends and the second document begins.

A list of documents in a single document chain that includes the first document and the second document is generated (block 706). For example, a list can be generated that identifies the documents in the document chain by including items that correspond to respective documents in the document chain. The list can be provided in any suitable way. In implementations, the list can be presented in the graphical user interface proximate to the displayed content, such as the side, bottom, or top. Alternatively, the list can be presented via a pop-up, overlay, or other user interface instrumentality that is configured to provide an indication of at least some of the documents in the document chain. In at least some embodiments, the items in the list can be selectable to navigate the browser interface to a corresponding document in the document chain.

A display order of the documents in the single document chain is modified based on a user input to change the list order of the documents in the list (block 708). For example, the documents included in the document chain are presented sequentially, according to an order in which the documents are opened. The display order of the documents in the document chain can be modified by the user changing the order of the documents, or the items, listed in the list. For example, the user may drag one or more items in the list from one location to another location in the list, thereby causing an associated document in the document chain to be moved to a corresponding location in the document chain.

An additional user input of an additional hyperlink embedded within one of the first document or the second document is received (block 710). In implementations, the additional hyperlink is associated with a third document. The user may select the additional hyperlink in any suitable way, examples of which are described above. The hyperlink can be located within any of the documents currently included in the document chain, and the hyperlink can be associated with another document that is to be opened responsive to selection of the hyperlink.

Responsive to the additional user input, the third document is appended to the second document to enable continuous scrolling through a single document chain that includes the first document, the second document, and the third document (block 712). This step can be performed in any suitable way. For example, when the user selects a new hyperlink, a corresponding document is appended to the end of the document chain. If the document chain currently includes the first and second documents, with the second document being appended to the end of the first document, then a new document (e.g., third document) is appended to the second document. Alternatively, the new document can be appended to the document chain at any location within the document chain. In at least some embodiments, the location for the new document in the document chain can be designated by the user.

The second document is closed responsive to a user input received to close the second document (block 714). The user input can close the second document in a variety of ways. For example, the user can close an item in the list of items that corresponds to the second document. By closing the item in the list, the item is removed from the list and the corresponding document is removed from the document chain. Alternatively, the user input can include a user selection of the second document, or a portion of the second document, displayed in the browser interface to cause the second document to close. Any of the documents in the document chain can be closed responsive to a user input received to close the document.

The single document chain is updated by appending the third document to the first document to enable continuous scrolling through the single document chain directly from the first document to the third document (block 716). Continuing with the above example, the second document was removed from the middle of the document chain, causing the document chain to have a missing portion between the first and third documents. Accordingly, the document chain can be updated by appending together the two documents that were previously appended to opposing ends of the closed document. This enables continuous scrolling through the document chain directly from the first document to the third document without interruption.

### Example System and Device

FIG. 8 illustrates an example system generally at 800 that includes an example computing device 802 that is representative of one or more computing systems and/or devices that may implement the various techniques described herein. This is illustrated through inclusion of document manager module 114, which may be configured to manage content displayed on the computing device 802. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

Cloud 814 includes and/or is representative of a platform 816 for resources 818. Platform 816 abstracts underlying functionality of hardware (e.g., servers) and software resources of the cloud 814. Resources 818 may include applications and/or data that can be utilized while computer processing is executed on servers that are remote from the computing device 802. Resources 818 can also include services 820 provided over the Internet and/or through a subscriber network, such as a cellular or Wi-Fi network.

Platform 816 may abstract resources and functions to connect computing device 802 with other computing devices. Platform 816 may also serve to abstract scaling of resources to provide a corresponding level of scale to encountered demand for resources 818 that are implemented via platform 816. Accordingly, in an interconnected device embodiment, implementation of functionality described herein may be distributed throughout system 800. For example, the functionality may be implemented in part on computing device 802 as well as via platform 816 that abstracts the functionality of cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method, comprising:
displaying content having one or more hyperlinks associated with additional content;
receiving a user selection of one said hyperlink;
responsive to receiving the user selection, adding the additional content associated with the selected hyperlink to the displayed content; and
displaying the content and the additional content together as a single content chain.

2. A computer-implemented method as recited in claim 1, wherein:
the content comprises a first document; and
the additional content comprises a second document that is different than the first document.

3. A computer-implemented method as recited in claim 1, wherein the content and the additional content are displayed within a same tab of a displayed browser interface.

4. A computer-implemented method as recited in claim 1, wherein the single content chain is configured to enable continuous scrolling from the content to the new content without interruption.

5. A computer-implemented method as recited in claim 1, wherein the user selection is initiated via a right click on a respective said hyperlink and a selection of a menu option to open the additional content together with the content.

6. A computer-implemented method as recited in claim 1, further comprising:
receiving a user input that selects an additional said hyperlink;
responsive to receiving the user input, appending at least a portion of new content to the additional content; and
displaying the content, the additional content, and the at least a portion of the new content as the single content chain.

7. A system, comprising:
a memory configured to store computer program instructions as a document manager module;
one or more processors to implement the document manager module that is configured to:
open a new document by appending the new document to an open document in response to a user selection of a hyperlink associated with the open document; and
initiate a display of the open document and the new document to be displayed as a single document chain.

8. A system as recited in claim 7, wherein the document manager module is configured to open the new document in a same browser window that displays the open document.

9. A system as recited in claim 7, wherein the document manager module is configured to open the new document in a same tab of a displayed browser interface that is used to display the open document.

10. A system as recited in claim 7, wherein the document manager module is configured to generate a list of documents that are included in the single document chain.

11. A system as recited in claim 10, wherein the documents in the list are individually closeable to cause removal of a closed document from the single document chain.

12. A system as recited in claim 10, wherein the document manager module is configured to change a display order of the documents in the single document chain responsive to a user input to change the display order of the documents in the list.

13. A system as recited in claim 7, wherein:
the open document includes multiple documents appended together, at least one of the multiple documents being associated with a hyperlink embedded in another one of the multiple documents; and
the document manager module is configured to append the new document to the multiple documents.

14. Computer-readable storage memory comprising instructions that are executable and, responsive to execution by one or more processors, cause the one or more processors to perform operations comprising:
receiving a user input of a hyperlink embedded within a first document, the hyperlink being associated with a second document; and
responsive to the user input, appending the second document to the first document to enable continuous scrolling from the first document to the second document.

15. Computer-readable storage memory as recited in claim 14, wherein the operations further comprise:
receiving an additional user input of an additional hyperlink embedded within one of the first document or the second document, the additional hyperlink being associated with a third document; and
responsive to the additional user input, appending the third document to the second document to enable continuous scrolling through a single document chain that includes the first document, the second document, and the third document.

16. Computer-readable storage memory as recited in claim 15, wherein the operations further comprise:
closing the second document responsive to a user input received to close the second document; and
updating the single document chain by appending the third document to the first document to enable continuous scrolling through the single document chain from the first document to the third document.

17. Computer-readable storage memory as recited in claim 14, wherein the user input comprises:
a right click on the hyperlink to initiate a display of a menu; and
a selection of an item in the menu to open the second document by appending the second document to the first document in a single document chain.

18. Computer-readable storage memory as recited in claim 14, wherein the operations further comprise:
generating a list of documents in a single document chain that includes the first document and the second document; and
modifying a display order of the documents in the single document chain based on a user input to change a listed order of the documents in the list.

19. Computer-readable storage memory as recited in claim 14, wherein:
the first document includes multiple documents appended together in a document chain; and
the second document is appended to an end of the document chain.

20. Computer-readable storage memory as recited in claim 14, wherein the second document comprises a file format that is different than a file format of the first document.
